(19) United States
(12) Patent Application Publication
(10) Pub. No.: US 2026/0104816 A1
(43) Pub. Date: Apr. 16, 2026

(54) DATA STORAGE METHOD AND DEVICE

(71) Applicant: SAMSUNG ELECTRONICS CO., LTD., Suwon-si (KR)

(72) Inventors: Weibang LIU, XiAn (CN); Sizhe XIONG, XiAn (CN); Ting ZHANG, XiAn (CN); Wenbin CAO, XiAn (CN); Sung-Jun PARK, XiAn (CN)

(73) Assignee: SAMSUNG ELECTRONICS CO., LTD., Suwon-si (KR)

(21) Appl. No.: 19/094,172

(22) Filed: Mar. 28, 2025

(30) Foreign Application Priority Data
Oct. 12, 2024 (CN) 202411426067.1

(51) Int. Cl. G06F 3/06

(52) U.S. Cl. CPC G06F 3/0655; G06F 3/0604; G06F 3/0679

(57) ABSTRACT

Provided is a data storage method and device, the data storage method including: acquiring data from a kernel of an operating system of a storage device; determining at least one data feature of the data; determining a data triage policy for the data to be stored based on an attribute parameter of the storage device and the at least one data feature; and triaging the data to be stored based on the data triage policy.

### CROSS-REFERENCE TO RELATED APPLICATIONS

This application is based on and claims priority to Chinese Patent Application No. 202411426067.1, filed on Oct. 12, 2024, the disclosure of which is incorporated by reference herein in its entirety.

### BACKGROUND

### 1. Field

The present disclosure relates to storage technology, and more particularly, to a data storage method and device.

### 2. Description of Related Art

In the related art, methods and related technologies for improving Universal Flash Storage (UFS) write performance in mobile devices include a WriteBooster technology and a host-side data triage technology.

The WriteBooster technology is a generic method published by the Joint Electron Device Engineering Council (JEDEC) to optimize UFS devices, it allocates a portion of the Universal Flash Storage space to be used as a Single-Level Cell (SLC), which is used as a cache. Specifically, when the host side has input/output (Input/Output) IO data writing into it, the data will be directly written to the single-level cell region first, and then while a flush command or device idle is received, the data in the single-level cell region is moved to the Triple-Level Cell (TLC)/Quad-Level Cell (QLC) region, in which the data is slower. In this scenario, writing directly to the single-level cell region will result in a significant performance improvement over writing to the slower Triple-Level Cell/Quad-Level Cell region. However, in the WriteBooster technology, when the host side continues to write a large amount of data for a period of time, the single-layer cell region will be filled, and if the flush command is not triggered, the subsequent data written by the host side can only be written to the slower three-layer cell/four-layer cell region due to the lack of space in the single-layer cell, and in this scenario, the write performance will revert to the original slower speed, which may result in lagging in the user experience.

The host-side data triage technology refers to the distinction between hot and cold data written on the host side. This technology is based on the WriteBooster, which has a data triage module that writes the determined hot data to the single-level cell buffer region, while the cold data is written directly to the slower three-level cell/four-level cell region. However, although the host-side data triage technique allows the host to distinguish between hot and cold data, so that the data with high priority is written to the single-level cell region and the situation that the single-level cell region is written to full quickly does not occur, the host-side data triage technique includes a data triage module which requires analysis of a large amount of data written by the host-side in order to differentiate the “hotness” priority. This analysis in turn introduces a large amount of computation and increases the load on the system. In addition, this data triage module is implemented in the kernel, and therefore takes a long time to port to other platforms.

For example, the existing methods and related techniques for improving the UFS write performance of mobile devices may suffer from high load, low portability, and an inability to maintain high performance for an indefinite period of time.

### SUMMARY

Provided are a data storage method and device, and more specifically a method and device designed to improve storage performance and avoid high load and low portability.

According to an aspect of the disclosure, a data storage method includes: acquiring data from a kernel of an operating system of a storage device; determining at least one data feature of the data; determining a data triage policy for the data to be stored based on an attribute parameter of the storage device and the at least one data feature; and triaging the data to be stored based on the data triage policy.

According to an aspect of the disclosure, a data storage device includes: memory storing one or more instructions; and at least one processor configured to execute the one or more instructions, wherein the one or more instructions, when executed by the at least one processor, cause the data storage device to: acquire data from a kernel of an operating system of a storage device, determine at least one data feature of the data, determine a data triage policy for the data to be stored based on an attribute parameter of the storage device and the at least one data feature, and triage the data to be stored based on the data triage policy.

According to an aspect of the disclosure, a non-transitory computer-readable storage medium stores a computer program that, when executed by at least one processor, causes the at least one processor to perform a data storage method, the data storage method including: acquiring data from a kernel of an operating system of a storage device; determining at least one data feature of the data; determining a data triage policy for the data to be stored based on an attribute parameter of the storage device and the at least one data feature; and triaging the data to be stored based on the data triage policy.

According to an aspect of the disclosure, a computing device includes: memory storing a computer program; and at least one processor configured to access and to execute the computer program and to operate as instructed by the computer program, the computer program including: data acquisition code configured to cause at least one of the at least one processor to acquire data from a kernel of an operating system of a storage device; feature determining code configured to cause at least one of the at least one processor to determine at least one data feature of the data; policy determining code configured to cause at least one of the at least one processor to determine a data triage policy for the data to be stored based on an attribute parameter of the storage device and the at least one data feature; and triage storage code configured cause at least one of the at least one processor to triage the data to be stored based on the data triage policy.

The data storage method and device according to embodiments of the present disclosure, by acquiring data from a kernel of an operating system of a storage device; determining at least one data feature of the data; determining a data triage policy for the data to be stored based on an attribute parameter of the storage device and the at least one data feature; and triaging the data to be stored based on the data triage policy, results in improved write performance of the storage device. This improved performance is maintained for an indefinite period of time, the number of data migrations of the storage device is reduced, and the lifespan of the storage device is increased.

### BRIEF DESCRIPTION OF THE DRAWINGS

The above and other features of certain embodiments of the present disclosure will be more apparent through the following description in conjunction with the accompanying drawings, in which:

FIG. 1 illustrates a flowchart of a data storage method according to one or more embodiments of the present disclosure;

FIG. 2 illustrates a schematic diagram of a data storage system according to one or more embodiments of the present disclosure;

FIG. 3 illustrates a schematic diagram of triaging by write types according to one or more embodiments of the present disclosure;

FIG. 4 illustrates a schematic diagram of triaging by write percentage according to one or more embodiments of the present disclosure;

FIG. 5 illustrates a block diagram of a data storage device according to one or more embodiments of the present disclosure; and

FIG. 6 illustrates a schematic diagram of a computing device according to one or more embodiments of the present disclosure.

### DETAILED DESCRIPTION

Reference will now be made in detail to embodiments of the present disclosure, examples of which are illustrated in the drawings, wherein the same reference numerals always refer to the same members. Embodiments are described below in order to explain the present disclosure by referring to the drawings.

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

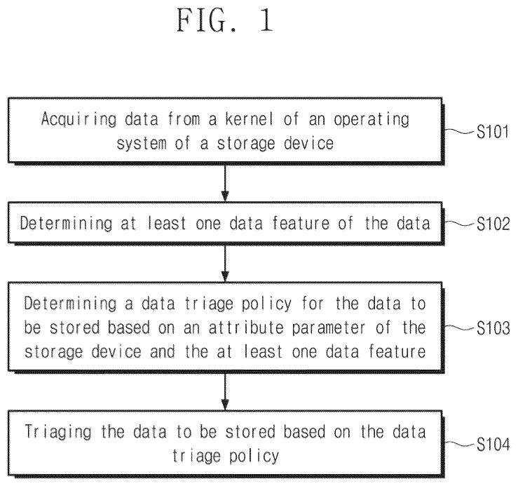

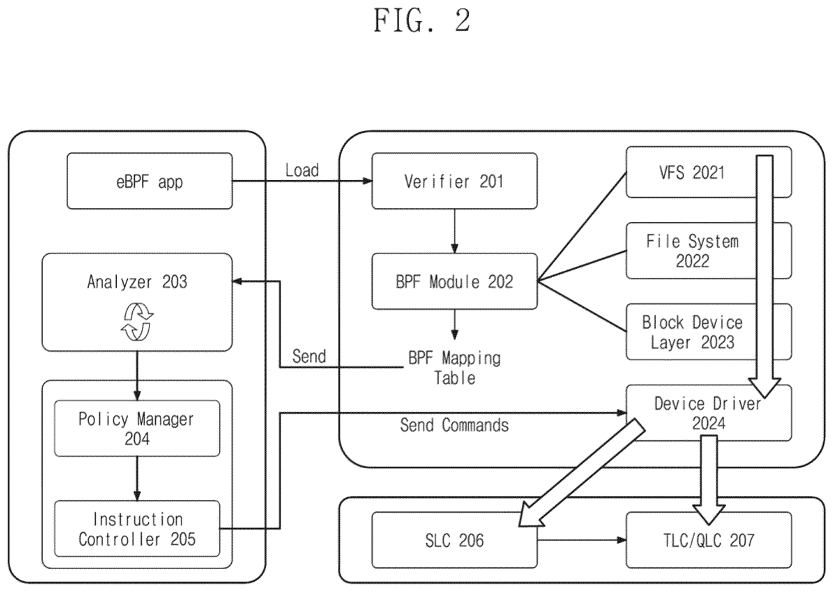

FIG. 1 illustrates a flowchart of a data storage method according to one or more embodiments of the present disclosure. FIG. 2 illustrates a structure schematic diagram of a data storage system according to one or more embodiments of the present disclosure.

Referring to FIG. 1, in operation S101, data is acquired from a kernel of an operating system of a storage device.

In one or more embodiments of the present disclosure, the acquisition of data from the kernel of the operating system of the storage device may include: acquiring the data through a preset filter program loaded into the kernel. Herein, the preset filter program may be, for example and without limitation, an Extensible Berkeley Packet Filter (eBPF) program. The data stream of the kernel can be accessed without intruding into the kernel of the operating system of the storage device based on the Extensible Berkeley Packet Filter technology.

In one or more embodiments of the present disclosure, the acquisition of the data through the preset filter program loaded into the kernel may include: obtaining data from respective data layers of the kernel through the preset filter program, in response to determining that the preset filter program loaded into the kernel passes a compliance verification of the kernel; and, storing the grabbed data in a preset mapping table to obtain the data. The data may be formatted based on the preset mapping table.

For example, as shown in FIG. 2, the eBPF application is first loaded into the kernel of the operating system of the storage device, and the kernel then calls a verifier 201 to check whether the eBPF application conforms to the specification. After determining that the specification is met, a kernel's BPF module 202 starts up and obtains data information from the kernel's various data layers and stores it in an eBPF mapping table (or a Map). The eBPF mapping table sends the formatted data to a user-state analyzer module (analyzer) 203. As shown in FIG. 2, the BPF module 202 may include a virtual file system (VFS) 2021, a file system 2022, a block device layer 2023, and a device driver 2024.

In operation S102, at least one data feature of the data is determined.

In one or more embodiments of the present disclosure, the at least one data feature may include at least one of a distribution of read and write types of the data, a read percentage of the data, a write percentage of the data, and a distribution of write types of the data. In addition, the at least one data feature may also be, for example, a distinguishing feature of a foreground process data/background process data. As shown in FIG. 2, after the Analyzer 203 obtains the formatted data transmitted from the kernel, it may use algorithmic statistical formulas (e.g., but not limited to, summation operations, classification calculations, etc.) to compute the data features, and then store those data features. And, after that, pass the data features on to the later policy manager 204.

In operation S103, a data triage policy for the data to be stored is determined based on an attribute parameter of the storage device and the at least one data feature. For example, to select a suitable data triage policy, the policy manager 204 in FIG. 2 reads the attribute parameter of the storage device after the data feature is received. In addition, the policy manager 204 selects a suitable data triage policy in the user state. Herein, the attribute parameter may be, for example but not limited to, a firmware version number.

In one or more embodiments of the present disclosure, the determining of the data triage policy for the data to be stored, based on the attribute parameter of the storage device and the at least one data feature, may include: determining whether the storage device supports a single-level cell pinned buffer, based on the attribute parameter; selecting a data feature for determining the data triage policy from the at least one data feature based on whether the storage device supports a single-level cell pinned buffer; and determining the data triage policy based on the selected data feature, thereby improving the accuracy of the data triage policy.

In one or more embodiments of the present disclosure, the selecting of the data feature for determining the data triage policy from the at least one data feature based on whether the storage device supports the single-level cell pinned buffer may include: selecting the write percentage of the data from the at least one data feature as the data feature for determining the data triage policy, when it is determined that the storage device does not support the single-level cell pinned buffer, thereby improving the accuracy of the data triage policy by selecting data features. Herein, when it is determined that the storage device does not support the single-level cell pinned buffer, it is preferable to select the write percentage of the data from the at least one data feature as the data feature for determining the data triage policy.

In one or more embodiments of the present disclosure, the determining of the data triage policy based on the selected data feature may include: determining the data triage policy based on the write percentage of the data, thereby improving the accuracy of the data triage policy by selecting data features.

In one or more embodiments of the present disclosure, the determining of the data triage policy based on the write percentage of the data may include: generating statistics regarding the write percentage of the data per unit of time; determining a result of a comparison of a minimum value in the write percentage and a threshold value; using a first region of a storage region as at least part of the data triage policy, when the minimum value is greater than or equal to the threshold value; and using a second region of the storage region as at least part of the data triage policy, when the minimum value is less than the threshold value, thereby improving the accuracy of the data triage policy by selecting data features. Herein, the write speed of the first region is greater than the write speed of the second region. For example, in this case, the data triage policy may include: writing the data to be stored to a first region (e.g., an SLC region) when a minimum value in the ratio of writes per unit of time is greater than or equal to a write percentage threshold; and writing the data to be stored to a second region (e.g., a non-SLC region) when a minimum value in the ratio of writes per unit of time is less than the write percentage threshold. The non-SLC region is a region other than the SLC region, e.g., a TLC region or a QLC region.

In one or more embodiments of the present disclosure, the selecting of the data feature for determining the data triage policy from the at least one data feature based on whether the storage device supports the single-level cell pinned buffer may include: selecting the distribution of write types of the data from the at least one data feature as the data feature for determining the data triage policy, when it is determined that the storage device supports the single-level cell pinned buffer, thereby improving the accuracy of the data triage policy by selecting data features. Herein, when it is determined that the storage device supports the single-level cell pinned buffer, it is preferable to select the distribution of write types of the data from the at least one data feature as the data feature for determining the data triage policy.

In one or more embodiments of the present disclosure, the determining of the data triage policy based on the selected data feature may include: determining the data triage policy based on the distribution of write types of the data, thereby improving the accuracy of the data triage policy.

In one or more embodiments of the present disclosure, the determining of the data triage policy based on the distribution of write types of the data may include: determining a proportion of write types in the data within a predetermined period of time based on the distribution of write types in the data; selecting a write type whose proportion satisfies a predetermined condition based on the proportion of write types in the data triage policy; and using the write type in the data triage policy as at least part of the data triage policy, thereby improving the accuracy of the data triage policy. For example, in this case, the data triage policy may include: writing the data to be stored to a first region (e.g., an SLC Pinned buffer region) when the distribution of the write types of the data satisfies the write types of the predetermined condition; and writing the data to be stored to a second region (e.g., an SLC normal region) when the distribution of the write types of the data does not satisfy the write types of the predetermined condition.

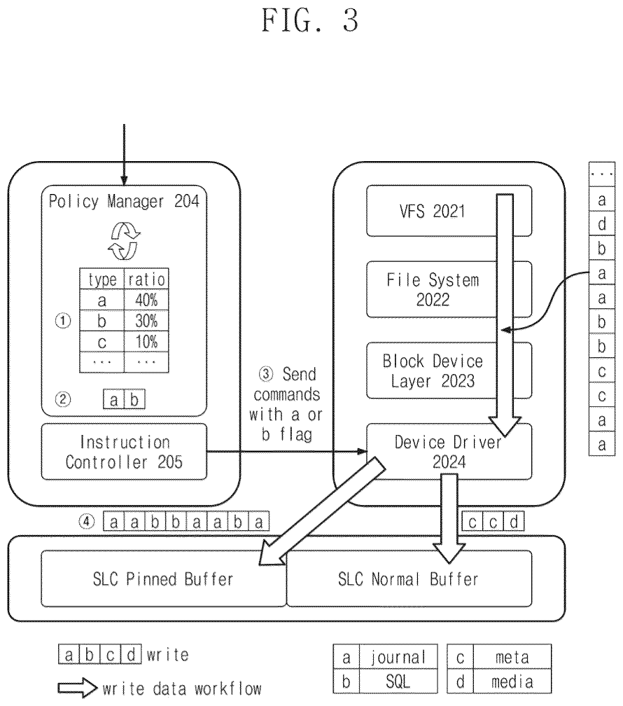

FIG. 3 illustrates a schematic diagram of triaging by write types according to one or more embodiments of the present disclosure.

As shown in FIG. 3, when the device version supports the Single Level Cell Pinned buffer (SLC Pinned buffer) characteristic, the policy manager 204 may generate statistics regarding the proportion of various write types within a given period of time (e.g., but not limited to, one minute, five minutes, etc.), select e.g., but not limited to, 2 to 3 write types whose proportion are the highest, and send the selected types (e.g., types a, b) to the instruction controller 205, and the instruction controller 205 then sends an instruction with the selected type (e.g., type a, b) to notify the device driver 2024 of the universal flash storage (UFS) device.

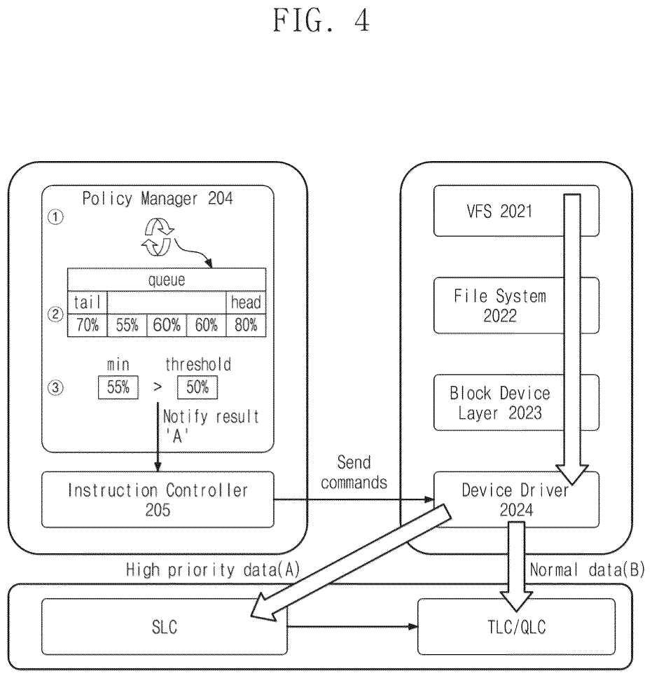

FIG. 4 illustrates a schematic diagram of triaging by write percentage according to one or more embodiments of the present disclosure.

As shown in FIG. 4, when the storage device does not support a SLC Pinned buffer, at this time, the policy manager 204 may use another algorithm. The policy manager 204 may generate statistics regarding, for example and without limitation, the proportion of data written per second (referred to as the “write ratio”), sequentially put the write ratio in a queue, record the last, for example and without limitation, five values in the queue, and identify the minimum value. The policy manger may then compare the minimum value with a threshold value, and based on the minimum value being greater than or equal to the threshold value, send an “A” instruction to the instruction controller 205, or based on the minimum value being less than the threshold value, send a “B” instruction to the instruction controller 205.

In addition, when it is determined that the storage device supports the single-level cell pinned buffer, the distribution of read and write types of the data or the read percentage of the data may also be selected from the at least one data feature as the data feature for determining the data triage policy. For example, in a case of selecting the distribution of read and write types of the data as the data feature for determining the data triage policy, when the distribution of read and write types of the data is greater than or equal to the read and write distribution threshold, the data triage policy triages the data to be stored to the SLC pinned buffer region; and when the distribution of read and write types of the data is less than the read and write distribution threshold, the data triage policy triages the data to be stored to the SLC normal region. In a case of selecting the read percentage of the data as the data feature for determining the data triage policy, when the read percentage of the data is greater than or equal to the read percentage threshold, the data triage policy triages the data to be stored to the SLC pinned buffer region; and when the read percentage of the data is less than the read percentage threshold, the data triage policy triages the data to be stored to the SLC normal region.

In addition, when it is determined that the storage device supports the single-level cell pinned buffer, the write percentage of the data also may be selected from the at least one data feature as the data feature for determining the data triage policy. When it is determined that the storage device supports the single-level cell pinned buffer, the foreground process data/background process data also may be selected from the at least one data feature as the data feature for determining the data triage policy.

In addition, when it is determined that the storage device does not support the single-level cell pinned buffer, the distribution of read and write types of the data or the read percentage of the data also may be selected from the at least one data feature as the data feature for determining the data triage policy. For example, in a case of selecting the distribution of read and write types of the data as the data feature for determining the data triage policy, when the distribution of read and write types of the data is greater than or equal to the read and write distribution threshold, the data triage policy triages the data to be stored to the SLC region; and when the distribution of read and write types of the data is less than the read and write distribution threshold, the data triage policy triages the data to be stored to the non-SLC region. In a case of selecting the read percentage of the data as the data feature for determining the data triage policy, when the read percentage of the data is greater than or equal to the read percentage threshold, the data triage policy triages the data to be stored to the SLC region; and when the read percentage of the data is less than the read percentage threshold, the data triage policy triages the data to be stored to the non-SLC region.

In addition, when it is determined that the storage device does not support the single-level cell pinned buffer, the write percentage of the data also may be selected from the at least one data feature as the data feature for determining the data triage policy. When it is determined that the storage device does not support the single-level cell pinned buffer, the foreground process data/background process data also may be selected from the at least one data feature as the data feature for determining the data triage policy.

In operation S104, the data to be stored is triaged based on the data triage policy. As shown in FIG. 2, the instruction controller 205, after receiving the data triage policy from the policy manager 204, sends corresponding control instructions to the device driver layer to control the writing of the data to be stored into the single-level cell (SLC) region or the triple-level cell/quadruple-level cell (TLC/QLC) region.

In one or more embodiments of the present disclosure, the triaging of the data to be stored based on the data triage policy may include: writing the data to be stored to the first region when the first region is used as at least part of the data triage policy; and writing the data to be stored to the second region when the second region is used as at least part of the data triage policy, thereby enabling the write performance of the storage device to be maximized, so that the write performance of the storage device is improved. As shown in FIG. 4, the instruction controller 205 receives the “A” instruction and sends a “data write to SLC region” instruction to the device driver 2024, and the subsequent write type of data goes to the SLC region of the universal flash storage (UFS) device; the instruction controller 205 receives the “B” instruction, and sends a “data write to TLC region/QLC region” instruction to the device driver 2024, and the subsequent write type of data goes to the TLC region or the QLC region of the universal flash storage (UFS) device.

In one or more embodiments of the present disclosure, the triaging of the data to be stored based on the data triage policy may include: writing the data to be stored whose write type is the write type in the data triage policy to a first region (a SLC pinned buffer region); and writing the data to be stored whose write type is not the write type in the data triage policy to a second region (a SLC normal region), thereby enabling the write performance of the storage device to be maximized, so that the write performance of the storage device is improved. For example, as shown in FIG. 3, once an instruction including the data triage policy is in effect, a subsequent selected write type is determined to have a high priority and is written to the SLC pinned buffer region, and unselected write types are written to the SLC normal region.

In one or more embodiments of the present disclosure, the triaging of the data to be stored based on the data triage policy may include: based on the data triage policy, writing data whose priority or importance satisfies a condition to a first region and writing data whose priority or importance step does not satisfy the condition to a second region, thereby enabling the write performance of the storage device to be maximized, so that the write performance of the storage device is improved. Herein, the write speed of the first region is greater than the write speed of the second region.

The data storage method according to one or more embodiments of the present disclosure can maintain high performance for an indefinite amount of time, reduce the number of data migrations of the storage device, and increase the lifespan of the storage device.

In addition, the data storage method according to the one or more embodiments of the present disclosure can obtain data by a preset filter program loaded into the kernel, thereby obtaining data of the kernel without intruding into the kernel, so that the portability of the data storage method according to the one or more embodiment of the present disclosure is increased. In addition, according to the one or more embodiments of the present disclosure, the load of an operating system of the storage device is not increased.

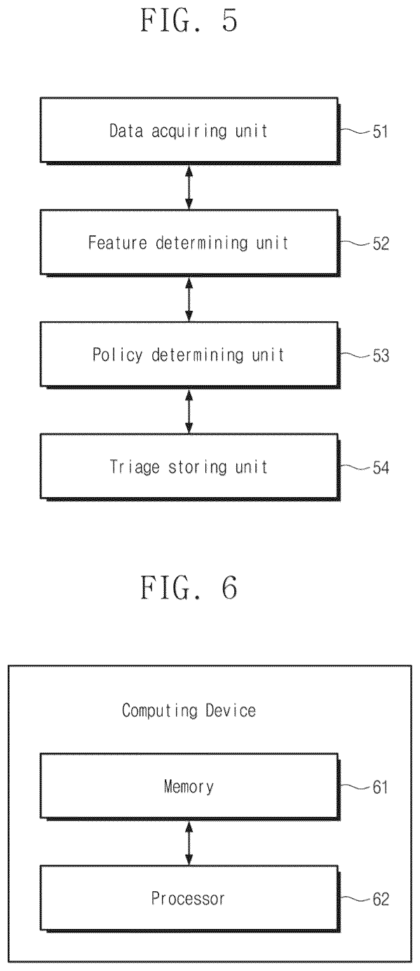

The data storage method according to embodiments of the present disclosure has been described above in conjunction with FIG. 1 to FIG. 4. Hereinafter, the data storage device according to embodiments of the present disclosure will be described with reference to FIG. 5.

FIG. 5 illustrates a block diagram of a data storage device according to one or more embodiments of the present disclosure.

Referring to FIG. 5, the data storage device includes a data acquiring unit 51, a feature determining unit 52, a policy determining unit 53, and a triage storing unit 54.

The data acquiring unit 51 is configured to acquire data from a kernel of an operating system of a storage device.

In one or more embodiments of the present disclosure, the data acquiring unit 51 may be configured to: acquire the data through a preset filter program loaded into the kernel.

In one or more embodiments of the present disclosure, the data acquiring unit 51 may be configured to: grab data from respective data layers of the kernel through the preset filter program, in response to determining that the preset filter program loaded into the kernel passes a compliance verification of the kernel; store the grabbed data in a preset mapping table to obtain the data.

The feature determining unit 52 is configured to determine at least one data feature of the data.

In one or more embodiments of the present disclosure, the at least one data feature may include at least one of a distribution of read and write types of the data, a read percentage of the data, a write percentage of the data, and a distribution of write types of the data.

The policy determining unit 53 is configured to determine a data triage policy for the data to be stored based on an attribute parameter of the storage device and the at least one data feature.

In one or more embodiments of the present disclosure, the policy determining unit 53 may be configured to: determine whether the storage device supports a single-level cell pinned buffer, based on the attribute parameter; select a data feature for determining the data triage policy from the at least one data feature based on whether the storage device supports a single-level cell pinned buffer; determine the data triage policy based on the selected data feature.

In one or more embodiments of the present disclosure, the policy determining unit 53 may be configured to: select the write percentage of the data from the at least one data feature as the data feature for determining the data triage policy, when it is determined that the storage device does not support the single-level cell pinned buffer; determine the data triage policy based on the write percentage of the data.

In one or more embodiments of the present disclosure, the policy determining unit 53 may be configured to: generate statistics regarding the write percentage of the data per unit of time; determine a comparing result of a minimum value in the write percentage and a threshold value; use a first region of a storage region as at least part of the data triage policy, when the minimum value is greater than or equal to the threshold value; use a second region of the storage region as at least part of the data triage policy, when the minimum value is less than the threshold value, wherein the write speed of the first region is greater than the write speed of the second region.

In one or more embodiments of the present disclosure, the policy determining unit 53 may be configured to: select the distribution of write types of the data from the at least one data feature as the data feature for determining the data triage policy, when it is determined that the storage device supports the single-level cell pinned buffer; determine the data triage policy based on the distribution of write types of the data.

In one or more embodiments of the present disclosure, the policy determining unit 53 may be configured to: determine a proportion of write types in the data within a predetermined period of time based on the distribution of write types in the data; select a write type whose proportion satisfies a predetermined condition based on the proportion of write types in the data triage policy; use the write type in the data triage policy as at least part of the data triage policy.

The triage storing unit 54 is configured to triage the data to be stored based on the data triage policy.

In one or more embodiments of the present disclosure, the triage storing unit 54 may be configured to: write the data to be stored to the first region when the first region is used as at least part of the data triage policy; write the data to be stored to the second region when the second region is used as at least part of the data triage policy.

In one or more embodiments of the present disclosure, the triage storing unit 54 may be configured to: write the data to be stored whose write type is the write type in the data triage policy to a first region, and write the data to be stored whose write type is not the write type in the data triage policy to a second region.

In one or more embodiments of the present disclosure, the triage storing unit 54 may be configured to: based on the data triage policy, write data whose priority or importance satisfies a condition to a first region and write data whose priority or importance step does not satisfy the condition to a second region, wherein the write speed of the first region is greater than the write speed of the second region.

In addition, according to one or more embodiments of the present disclosure, there is also provided a non-transitory computer-readable storage medium having a computer program stored thereon, and when the computer program is executed, the data storage method according to embodiments of the present disclosure is implemented.

In one or more embodiments of the present disclosure, the computer-readable storage medium may carry one or more programs that, when executed, may implement the following operations: acquiring data from a kernel of an operating system of a storage device; determining at least one data feature of the data; determining a data triage policy for the data to be stored based on an attribute parameter of the storage device and the at least one data feature; triaging the data to be stored based on the data triage policy.

The computer-readable storage medium may be, for example and without limitation, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above.

In one or more embodiments of the present disclosure, a computer-readable storage medium may be any tangible medium that contains or stores a computer program code (i.e., one or more instructions) that may be used by or in conjunction with an instruction execution system, apparatus, or device. The computer program code contained on the computer-readable storage medium may be transmitted using any appropriate medium, including but not limited to wire, fiber optic cable, RF (radio frequency), etc., or any suitable combination of the above. The computer-readable storage medium may be included in any device, and it may also exist alone without being incorporated into the device.

In addition, according to embodiments of the present disclosure, there also provides a computer program product, wherein instructions in the computer program product may be executed by one or more processors of the computer device to complete the data storage method according to embodiments of the present disclosure.

The data storage device according to embodiments of the present disclosure has been described above in conjunction with FIG. 5. Next, a computing device according to embodiments of the present disclosure will be described in conjunction with to FIG. 6.

FIG. 6 illustrates a schematic diagram of a computing device according to embodiments of the present disclosure.

Referring to FIG. 6, a computing device according to one or more embodiments of the present disclosure may include a memory 61 and a processor 62, wherein the memory 61 stores computer program code. When the computer program code is executed by the processor 62, the data storage method according to embodiments of the present disclosure may be implemented.

The processor 62 may be implemented as a digital signal processor (DSP) processing digital signals, a microprocessor, or a time controller (TCON). However, the disclosure is not limited thereto, and the processor 62 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the processor 62 may be implemented as a system on chip (SoC) having a processing algorithm stored therein or large scale integration (LSI), or in the form of a field programmable gate array (FPGA). The processor 62 may perform various functions by executing computer executable instructions stored in the memory 61. The processor 62 may be implemented as one or more processors.

In one or more embodiments of the present disclosure, when the computer program is executed by the processor 42, the following operations may be implemented: acquiring data from a kernel of an operating system of a storage device; determining at least one data feature of the data; determining a data triage policy for the data to be stored based on an attribute parameter of the storage device and the at least one data feature; triaging the data to be stored based on the data triage policy.

The computing device in one or more embodiments of the present disclosure may include, but are not limited to, devices such as a mobile telephone, a laptop, a PDA (personal digital assistant), a PAD (tablet computer), a desktop computer, etc. The computing device shown in FIG. 6 is only an example, and should not impose any limitation on the function and scope of use of embodiments of the present disclosure.

The data storage method and device according to embodiments of the present disclosure have been described above with reference to FIGS. 1-6. However, it should be understood: the data storage device shown in FIG. 5 may be respectively configured as software, hardware, firmware or any combination of the above to perform specific functions, and the computing device shown in FIG. 6 is not limited to including the above shown components, but some components may be added or deleted according to needs, and the above components may also be combined.

The data storage method and device according to embodiments of the present disclosure, by acquiring data from a kernel of an operating system of a storage device; determining at least one data feature of the data; determining a data triage policy for the data to be stored based on an attribute parameter of the storage device and the at least one data feature; triaging the data to be stored based on the data triage policy, the write performance of the storage device is improved, high performance is maintained for an indefinite period of time, the number of data migrations of the storage device is reduced, and the lifespan of the storage device is increased.

Although the present disclosure has been specifically shown and described with reference to embodiments thereof, those skilled in the art should understand that various changes of the forms and details may be made without departing from the spirit and scope of the present disclosure as defined by the claims.

According to some examples, a data storage method includes: acquiring data from a kernel of an operating system of a storage device; determining at least one data feature of the data; determining a data triage policy for the data to be stored based on an attribute parameter of the storage device and the at least one data feature; and triaging the data to be stored based on the data triage policy. The acquiring of data from the kernel of the operating system of the storage device may include: acquiring the data through a preset filter program loaded into the kernel. The acquiring of the data through the preset filter program loaded into the kernel may include: based on determining that the preset filter program loaded into the kernel passes a compliance verification of the kernel, obtaining data from one or more data layers of the kernel through the preset filter program; and storing the obtained data in a preset mapping table. The determining of the data triage policy for the data to be stored based on the attribute parameter of the storage device and the at least one data feature may include: determining, based on the attribute parameter, whether the storage device supports a single-level cell pinned buffer; selecting a data feature for determining the data triage policy from the at least one data feature based on a result of the determining whether the storage device supports the single-level cell pinned buffer; and determining the data triage policy based on the selected data feature. The at least one data feature may include at least one of a distribution of read and write types of the data, a read percentage of the data, a write percentage of the data, and a distribution of write types of the data. The selecting of the data feature for determining the data triage policy from the at least one data feature based on the result of the determining whether the storage device supports the single-level cell pinned buffer may include: based on determining that the storage device does not support the single-level cell pinned buffer, selecting the write percentage of the data from the at least one data feature as the data feature for determining the data triage policy. The determining of the data triage policy based on the write percentage of the data may include generating statistics regarding the write percentage of the data per unit of time; comparing a minimum value in the write percentage and a threshold value; based on the minimum value being greater than or equal to the threshold value, using a first region of a storage region as at least part of the data triage policy; and based on the minimum value being less than the threshold value, using a second region of the storage region as at least part of the data triage policy, and wherein the write speed of the first region is greater than the write speed of the second region. The triaging the data to be stored based on the data triage policy may include: based on the first region being used as at least part of the data triage policy, writing the data to be stored to the first region; and based on the second region being used as at least part of the data triage policy, writing the data to be stored to the second region. The selecting of the data feature for determining the data triage policy from the at least one data feature based on the result of the determining whether the storage device supports the single-level cell pinned buffer may include: based on determining that the storage device supports the single-level cell pinned buffer, selecting the distribution of write types of the data from the at least one data feature as the data feature for determining the data triage policy. The determining the data triage policy based on the distribution of write types of the data may include: determining a proportion of write types in the data within a predetermined period of time based on the distribution of write types in the data; selecting a write type having a proportion that satisfies a predetermined condition based on the proportion of write types in the data triage policy; and using the selected write type in the data triage policy as at least part of the data triage policy. The triaging the data to be stored based on the data triage policy may include: writing the data to be stored having the selected write type to a first region, and writing the data to be stored having a write type other than the selected write type to a second region. The triaging of the data to be stored based on the data triage policy may include: based on the data triage policy, writing data having a priority that satisfies a condition to a first region, and writing data having a priority that does not satisfy the condition to a second region, and wherein the write speed of the first region is greater than the write speed of the second region.

According to some examples, a data storage device includes: memory storing one or more instructions; and at least one processor configured to execute the one or more instructions, wherein the one or more instructions, when executed by the at least one processor, cause the data storage device to: acquire data from a kernel of an operating system of a storage device, determine at least one data feature of the data, determine a data triage policy for the data to be stored based on an attribute parameter of the storage device and the at least one data feature, and triage the data to be stored based on the data triage policy. The one or more instructions, when executed by the at least one processor, may cause the data storage device to: acquire the data through a preset filter program loaded into the kernel. The one or more instructions, when executed by the at least one processor, may cause the data storage device to: based on determining that the preset filter program loaded into the kernel passes a compliance verification of the kernel, obtain data from one or more data layers of the kernel through the preset filter program, and store the obtained data in a preset mapping table. The one or more instructions, when executed by the at least one processor, may cause the data storage device to: determine, based on the attribute parameter, whether the storage device supports a single-level cell pinned buffer, select a data feature for determining the data triage policy from the at least one data feature based on a result of the determination of whether the storage device supports the single-level cell pinned buffer, and determine the data triage policy based on the selected data feature. The at least one data feature may include at least one of a distribution of read and write types of the data, a read percentage of the data, a write percentage of the data, and a distribution of write types of the data. The one or more instructions, when executed by the at least one processor, may cause the data storage device to: based on determining that the storage device does not support the single-level cell pinned buffer, select the write percentage of the data from the at least one data feature as the data feature for determining the data triage policy. The one or more instructions, when executed by the at least one processor, may cause the data storage device to: generate statistics regarding the write percentage of the data per unit of time, compare a minimum value in the write percentage and a threshold value, based on the minimum value being greater than or equal to the threshold value, use a first region of a storage region as at least part of the data triage policy, and based on the minimum value being less than the threshold value, use a second region of the storage region as at least part of the data triage policy, and wherein the write speed of the first region is greater than the write speed of the second region. The one or more instructions, when executed by the at least one processor, may cause the data storage device to: based on the first region being used as at least part of the data triage policy, write the data to be stored to the first region, and based on the second region being used as at least part of the data triage policy, write the data to be stored to the second region. The one or more instructions, when executed by the at least one processor, may cause the data storage device to: based on determining that the storage device supports the single-level cell pinned buffer, select the distribution of write types of the data from the at least one data feature as the data feature for determining the data triage policy. The one or more instructions, when executed by the at least one processor, may cause the data storage device to: determine a proportion of write types in the data within a predetermined period of time based on the distribution of write types in the data, select a write type having a proportion that satisfies a predetermined condition based on the proportion of write types in the data triage policy, and use the selected write type in the data triage policy as at least part of the data triage policy. The one or more instructions, when executed by the at least one processor, may cause the data storage device to: write the data to be stored having the selected write type to a first region, and write the data to be stored having a write type other than the selected write type to a second region. The one or more instructions, when executed by the at least one processor, may cause the data storage device to: based on the data triage policy, write data having a priority that satisfies a condition to a first region, and write data having a priority that does not satisfy the condition to a second region, and wherein the write speed of the first region is greater than the write speed of the second region.

According to some examples, a non-transitory computer-readable storage medium stores a computer program that, when executed by at least one processor, causes the at least one processor to perform a data storage method, the data storage method including: acquiring data from a kernel of an operating system of a storage device; determining at least one data feature of the data; determining a data triage policy for the data to be stored based on an attribute parameter of the storage device and the at least one data feature; and triaging the data to be stored based on the data triage policy.

According to some examples, a computing device includes: memory storing a computer program; and at least one processor configured to access and to execute the computer program and to operate as instructed by the computer program, the computer program including: data acquisition code configured to cause at least one of the at least one processor to acquire data from a kernel of an operating system of a storage device; feature determining code configured to cause at least one of the at least one processor to determine at least one data feature of the data; policy determining code configured to cause at least one of the at least one processor to determine a data triage policy for the data to be stored based on an attribute parameter of the storage device and the at least one data feature; and triage storage code configured cause at least one of the at least one processor to triage the data to be stored based on the data triage policy.

What is claimed is:

1. A data storage method comprising:
acquiring data from a kernel of an operating system of a storage device;
determining at least one data feature of the data;
determining a data triage policy for the data to be stored based on an attribute parameter of the storage device and the at least one data feature; and
triaging the data to be stored based on the data triage policy.

2. The data storage method of claim 1, wherein the acquiring data from the kernel of the operating system of the storage device comprises:
acquiring the data through a preset filter program loaded into the kernel.

3. The data storage method of claim 2, wherein the acquiring the data through the preset filter program loaded into the kernel comprises:
based on determining that the preset filter program loaded into the kernel passes a compliance verification of the kernel, obtaining data from one or more data layers of the kernel through the preset filter program; and
storing the obtained data in a preset mapping table.

4. The data storage method of claim 1, wherein the determining the data triage policy for the data to be stored based on the attribute parameter of the storage device and the at least one data feature comprises:
determining, based on the attribute parameter, whether the storage device supports a single-level cell pinned buffer;
selecting a data feature for determining the data triage policy from the at least one data feature based on a result of the determining whether the storage device supports the single-level cell pinned buffer; and
determining the data triage policy based on the selected data feature.

5. The data storage method of claim 4, wherein the at least one data feature comprises at least one of a distribution of read and write types of the data, a read percentage of the data, a write percentage of the data, and a distribution of write types of the data.

6. The data storage method of claim 5, wherein the selecting the data feature for determining the data triage policy from the at least one data feature based on the result of the determining whether the storage device supports the single-level cell pinned buffer comprises:
based on determining that the storage device does not support the single-level cell pinned buffer, selecting the write percentage of the data from the at least one data feature as the data feature for determining the data triage policy.

7. The data storage method of claim 6, wherein the determining the data triage policy based on the write percentage of the data comprises:
generating statistics regarding the write percentage of the data per unit of time;
comparing a minimum value in the write percentage and a threshold value;
based on the minimum value being greater than or equal to the threshold value, using a first region of a storage region as at least part of the data triage policy; and
based on the minimum value being less than the threshold value, using a second region of the storage region as at least part of the data triage policy, and
wherein the write speed of the first region is greater than the write speed of the second region.

8. The data storage method of claim 7, wherein the triaging the data to be stored based on the data triage policy comprises:
based on the first region being used as at least part of the data triage policy, writing the data to be stored to the first region; and
based on the second region being used as at least part of the data triage policy, writing the data to be stored to the second region.

9. The data storage method of claim 5, wherein the selecting the data feature for determining the data triage policy from the at least one data feature based on the result of the determining whether the storage device supports the single-level cell pinned buffer comprises:
based on determining that the storage device supports the single-level cell pinned buffer, selecting the distribution of write types of the data from the at least one data feature as the data feature for determining the data triage policy.

10. The data storage method of claim 9, wherein the determining the data triage policy based on the distribution of write types of the data comprises:
determining a proportion of write types in the data within a predetermined period of time based on the distribution of write types in the data;
selecting a write type having a proportion that satisfies a predetermined condition based on the proportion of write types in the data triage policy; and
using the selected write type in the data triage policy as at least part of the data triage policy.

11. The data storage method of claim 10, wherein the triaging the data to be stored based on the data triage policy comprises:
writing the data to be stored having the selected write type to a first region, and
writing the data to be stored having a write type other than the selected write type to a second region.

12. The data storage method according to claim 1, wherein the triaging of the data to be stored based on the data triage policy comprises:
based on the data triage policy, writing data having a priority that satisfies a condition to a first region, and writing data having a priority that does not satisfy the condition to a second region, and
wherein the write speed of the first region is greater than the write speed of the second region.

13. A data storage device comprising:
memory storing one or more instructions; and
at least one processor configured to execute the one or more instructions,
wherein the one or more instructions, when executed by the at least one processor, cause the data storage device to:
acquire data from a kernel of an operating system of a storage device,
determine at least one data feature of the data,
determine a data triage policy for the data to be stored based on an attribute parameter of the storage device and the at least one data feature, and
triage the data to be stored based on the data triage policy.

14. The data storage device of claim 13, wherein the one or more instructions, when executed by the at least one processor, cause the data storage device to:
acquire the data through a preset filter program loaded into the kernel.

15. The data storage device of claim 14, wherein the one or more instructions, when executed by the at least one processor, cause the data storage device to:
based on determining that the preset filter program loaded into the kernel passes a compliance verification of the kernel, obtain data from one or more data layers of the kernel through the preset filter program, and
store the obtained data in a preset mapping table.

16. The data storage device of claim 13, wherein the one or more instructions, when executed by the at least one processor, cause the data storage device to:
determine, based on the attribute parameter, whether the storage device supports a single-level cell pinned buffer,
select a data feature for determining the data triage policy from the at least one data feature based on a result of the determination of whether the storage device supports the single-level cell pinned buffer, and
determine the data triage policy based on the selected data feature.

17. The data storage device of claim 16, wherein the at least one data feature comprises at least one of a distribution of read and write types of the data, a read percentage of the data, a write percentage of the data, and a distribution of write types of the data.

18. The data storage device of claim 17, wherein the one or more instructions, when executed by the at least one processor, cause the data storage device to:
based on determining that the storage device does not support the single-level cell pinned buffer, select the write percentage of the data from the at least one data feature as the data feature for determining the data triage policy.

19. The data storage device of claim 18, wherein the one or more instructions, when executed by the at least one processor, cause the data storage device to:
generate statistics regarding the write percentage of the data per unit of time,
compare a minimum value in the write percentage and a threshold value,
based on the minimum value being greater than or equal to the threshold value, use a first region of a storage region as at least part of the data triage policy, and
based on the minimum value being less than the threshold value, use a second region of the storage region as at least part of the data triage policy, and
wherein the write speed of the first region is greater than the write speed of the second region.

20. A non-transitory computer-readable storage medium storing a computer program that, when executed by at least one processor, causes the at least one processor to perform a data storage method, the data storage method comprising:
acquiring data from a kernel of an operating system of a storage device;
determining at least one data feature of the data;
determining a data triage policy for the data to be stored based on an attribute parameter of the storage device and the at least one data feature; and
triaging the data to be stored based on the data triage policy.
